(19) United States
(12) Patent Application Publication
(10) Pub. No.: US 2026/0366609 A1
(43) Pub. Date: Nov. 19, 2026

(54) ELECTRIC DRIVE UNIT HAVING A DISCONNECT ASSEMBLY

(71) Applicant: BorgWarner Inc., Auburn Hills, MI (US)

(72) Inventors: Christopher Anthony Chirco, Romeo, MI (US); Joseph Desmond Mastie, Canton, MI (US); Dean Jeffrey Schneider, Washington, MI (US)

(21) Appl. No.: 19/668,946

(22) Filed: May 6, 2026

Related U.S. Application Data
(60) Provisional application No. 63/882,518, filed on Sep. 16, 2025.
(60) Provisional application No. 63/806,435, filed on May 15, 2025.

(51) Int. Cl. F16H 48/34; F16H 48/06; H02K 7/116; H02K 17/02; F16H 48/42

(52) U.S. Cl. CPC F16H 48/34; F16H 48/06; H02K 7/116; H02K 17/02; F16H 2048/343; F16H 2048/423

(57) ABSTRACT

An electric drive unit includes a housing assembly defining a housing interior within which an electric machine, a reduction gearset, and a differential assembly are disposed. A stub shaft is coupled to a second side gear of the differential assembly and includes a first spline portion. An axle receiving member is disposed adjacent to the stub shaft and includes a second spline portion. A disconnect assembly is operable between a connected state in which the disconnect assembly couples the axle receiving member and the stub shaft, and a disconnected state in which the disconnect assembly decouples the axle receiving member and the stub shaft. The disconnect assembly includes an actuator with an armature and a shift collar having a shift spline portion coupled to the armature for translation along the first axis to selectively engage and disengage the first spline portion and the second spline portion.

### CROSS-REFERENCE TO RELATED APPLICATIONS

The present application claims priority to and all the benefits of U.S. Provisional Patent Application Nos. 63/806,435 filed on May 15, 2025, and 63/882,518 filed Sep. 16, 2025, which are hereby expressly incorporated herein by reference in their entirety.

### BACKGROUND OF THE INVENTION

### 1. Field of the Invention

The present disclosure relates generally to an electric drive unit having a disconnect assembly.

### 2. Description of Related Art

As electrification of vehicles continues to proliferate, there is an increasing desire to reduce parasitic losses within drivetrain components to improve energy consumption and extend driving range. Electric drive units typically package rotating components, such as an electric machine, a reduction gearset, and a differential assembly, within a housing interior of a housing assembly. During vehicle operation in which the electric machine is not being used to propel the vehicle but the vehicle remains in motion, the rotating components of the electric drive unit may be back-driven from the wheels, resulting in parasitic losses attributable to continued rotation of the electric machine and the associated drivetrain componentry. Incorporating a disconnect assembly within the electric drive unit to selectively isolate the electric machine from the wheels during such conditions is one approach for reducing these parasitic losses. However, integrating a disconnect assembly within the compact envelope of an electric drive unit raises packaging, manufacturing, and reliability challenges. To this end, there remains a need for an improved electric drive unit having a disconnect assembly.

### SUMMARY AND ADVANTAGES

The present disclosure is generally directed to an electric drive unit. The electric drive unit includes a housing assembly extending along a first axis and defining a housing interior. The electric drive unit also includes an electric machine disposed in the housing interior, a reduction gearset disposed in the housing interior and coupled to the electric machine, and a differential assembly disposed in the housing interior and coupled to the reduction gearset such that the reduction gearset transmits torque between the electric machine and the differential assembly. The differential assembly includes a pinion carrier supported for rotation about the first axis. The differential assembly also includes a first side gear disposed in the pinion carrier for rotation relative to the pinion carrier about the first axis and configured to be coupled to a first output shaft, and a second side gear disposed in the pinion carrier opposite the first side gear for rotation relative to the pinion carrier about the first axis. The differential assembly further includes a plurality of pinion gears coupled to the pinion carrier for rotation about a second axis transverse to the first axis. Each of the plurality of pinion gears is meshed with the first side gear and the second side gear to transfer torque from the pinion carrier to the first side gear and the second side gear. The electric drive unit further includes a stub shaft disposed in the housing interior and coupled to the second side gear for rotation with the second side gear about the first axis, with the stub shaft including a first spline portion. The electric drive unit further includes an axle receiving member disposed adjacent to the stub shaft in the housing interior for rotation relative to the stub shaft about the first axis, with the axle receiving member including a second spline portion disposed adjacent to the first spline portion of the stub shaft, and with the axle receiving member configured to be coupled to a second output shaft.

The electric drive unit further includes a disconnect assembly operable between (i) a connected state where the disconnect assembly couples the axle receiving member and the stub shaft such that the differential assembly transfers torque to the axle receiving member and the first side gear, and (ii) a disconnected state where the disconnect assembly decouples the axle receiving member and the stub shaft such that the differential assembly does not transfer torque to the axle receiving member. The disconnect assembly includes an actuator including an armature selectively movable along the first axis between a first position and a second position spaced from the first position along the first axis. The disconnect assembly further includes a shift collar including a shift spline portion disposed annularly about the first axis and engaged with one of the first spline portion of the stub shaft and the second spline portion of the axle receiving member for rotation with the one of the first spline portion and the second spline portion about the first axis. The shift collar is coupled to the armature for translation along the first axis such that (i) in response to movement of the armature to the first position, the shift collar is configured to translate along the first axis to a connected position where the shift spline portion further engages the other of the first spline portion and the second spline portion such that the stub shaft and the axle receiving member are connected for concurrent rotation about the first axis to arrange the disconnect assembly in the connected state, and (ii) in response to movement of the armature to the second position, the shift collar is configured to translate along the first axis to a disconnected position where the shift spline portion disengages the other of the first spline portion and the second spline portion such that the stub shaft and the axle receiving member are permitted to rotate relative to each other about the first axis to arrange the disconnect assembly in the disconnected state.

Advantageously, the arrangement of the stub shaft, the axle receiving member, and the disconnect assembly according to the present disclosure facilitates selective disconnection of the axle receiving member (and, thus, the second output shaft) from the second side gear of the differential assembly, thereby inhibiting back-driving of the electric machine from the wheels and reducing parasitic losses attributable to continued rotation of these components when torque transfer through the differential assembly is not required.

### BRIEF DESCRIPTION OF THE DRAWINGS

Other advantages of the present disclosure will be readily appreciated, as the same becomes better understood by reference to the following detailed description when considered in connection with the accompanying drawings.

FIG. 1 is a cross-sectional representation of an electric drive unit according to the present disclosure.

FIG. 2 is a partial exploded cross-sectional representation of the electric drive unit of FIG. 1 illustrating a differential assembly, a stub shaft, an axle receiving member, and a disconnect assembly of the electric drive unit.

FIG. 3A is a partial cross-sectional representation of the electric drive unit illustrating the disconnect assembly of the electric drive unit in a connected state.

FIG. 3B is a partial cross-sectional representation of the electric drive unit illustrating the disconnect assembly of the electric drive unit in a disconnected state.

FIG. 4A is a partial perspective cross-sectional representation of the electric drive unit illustrating the disconnect assembly of the electric drive unit in the connected state.

FIG. 4B is a partial perspective cross-sectional representation of the electric drive unit illustrating the disconnect assembly of the electric drive unit in the disconnected state.

FIG. 5 is a partial cross-sectional representation of the electric drive unit schematically illustrating torque flow through the reduction gearset, the differential assembly, and the disconnect assembly when the disconnect assembly is in the connected state.

### DETAILED DESCRIPTION OF THE INVENTION

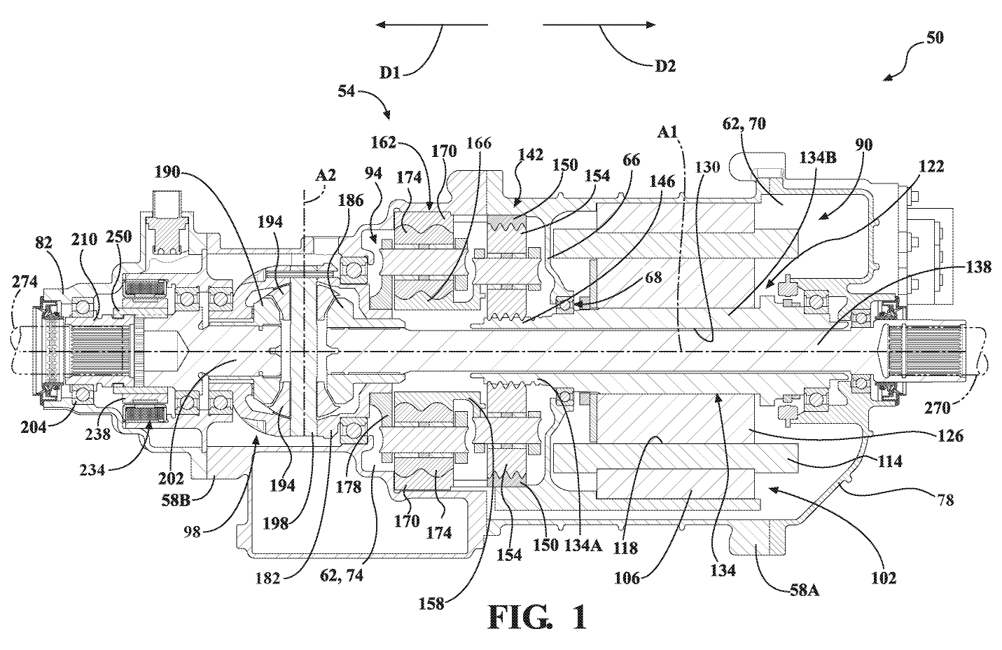

Referring to the drawings, wherein like reference numerals are used to identify like or identical components in the various views, FIGS. 1-5 illustrate an electric drive unit 50 according to the present disclosure. The electric drive unit 50 according to the present disclosure is generally configured for use in an electrified vehicle for providing propulsion torque and/or for receiving regenerative braking torque. While the electric drive unit 50 according to the present disclosure is described in the context of automotive applications, other vehicle applications employing the electric drive unit 50 are also contemplated including, but not limited to, heavy duty trucks, agricultural vehicles, construction vehicles, and recreational vehicles.

Referring to FIG. 1, the electric drive unit 50 includes a housing assembly 54. The housing assembly 54 includes a main housing body 58 extending along a first axis A1 between a first end 58A and a second end 58B spaced from the first end 58A in a first direction D1 along the first axis A1. The main housing body 58 defines a housing interior 62 about the first axis A1. The electric drive unit 50 further includes various components disposed in the housing interior 62 which rotate in the housing interior 62 including an electric machine 90, a differential assembly 98, and a reduction gearset 94 coupled to the electric machine 90 and the differential assembly 98 for transmitting torque between the electric machine 90 and the differential assembly 98. Exemplary configurations of the electric machine 90, the reduction gearset 94, and the differential assembly 98 are shown throughout the FIGS. and described in further detail below.

In the illustrated configuration, the main housing body 58 includes a divider wall 66 that subdivides the housing interior 62 into a first chamber 70 and a second chamber 74 extending along the first axis A1. The first chamber 70 is delimited by the divider wall 66 in the first direction D1, and the second chamber 74 is delimited by the divider wall 66 in a second direction D2 opposite the first direction D1. In the illustrated configuration, the electric machine 90 is disposed in the first chamber 70, the differential assembly 98 is disposed in the second chamber 74, and the reduction gearset 94 is disposed in the second chamber 74. Other configurations of the housing interior 62 are contemplated, including configurations in which the divider wall 66 is omitted and configurations in which the electric machine 90, the reduction gearset 94, and the differential assembly 98 are otherwise distributed within the housing interior 62.

With continued reference to FIG. 1, the housing assembly 54 may further include a first end cover 78 coupled to the first end 58A of the main housing body 58 to delimit the housing interior 62 in the second direction D2, and a second end cover 82 coupled to the second end 58B of the main housing body 58 to delimit the housing interior 62 in the first direction D1. In the illustrated configuration, the first end cover 78 and the second end cover 82 are formed as separate components that are removably coupled to the first end 58A and the second end 58B, respectively, so that the internal componentry of the electric drive unit 50 is accessible for service, inspection, or replacement. Other configurations where the first end cover 78 and/or the second end cover 82 is/are formed integrally or is/are otherwise permanently coupled with the main housing body 58 are contemplated.

As described above, the electric drive unit 50 includes the electric machine 90. The electric machine 90 is generally configured to generate torque for transfer through the reduction gearset 94 and the differential assembly 98 to propel the vehicle, and may further be configured to receive torque such that the electric machine 90 operates as a generator to regeneratively brake the vehicle. The configuration of the electric machine 90 is not limited for the purposes of this disclosure. Exemplary configurations of the electric machine 90 include permanent magnet synchronous motors, wound-field synchronous motors, switched reluctance motors, synchronous reluctance motors, brushless DC motors, and asynchronous induction motors. As best shown in FIG. 1, which represents an asynchronous induction motor configuration, the electric machine 90 includes a stator 102 coupled to the housing assembly 54 and disposed annularly about the first axis A1. While the configuration of the stator 102 is not necessarily limited for the purposes of this disclosure, in the illustrated configuration, the stator 102 includes a stator body 106 and stator windings 114 supported relative to the stator body 106. In one implementation, the stator windings 114 can be hairpin stator windings; however, other types of stator windings 114 are contemplated. The stator windings 114 can be coupled to a vehicle battery via an inverter and other power electronics that selectively invert the direct current (DC) electrical power stored in the vehicle battery into alternating current (AC) electrical current, and supply the AC electrical current to the stator windings 114 to energize the stator windings 114.

With continued reference to FIG. 1, in the illustrated configuration, the stator 102 defines a stator bore 118, and the electric machine 90 further includes a rotor 122 disposed in the stator bore 118 for rotation relative to the stator 102 about the first axis A1 in response to energization of the stator 102 (e.g. in response to energization of the stator windings 114). The rotor 122 includes a rotor body 126 disposed in the stator bore 118 and a rotor shaft 134 extending along the first axis A1 between a first rotor shaft portion 134A coupled to the rotor body 126 such that the rotor shaft 134 rotates with the rotor body 126 about the first axis A1 in response to energization of the stator 102, and a second rotor shaft portion 134B extending from the first rotor shaft portion 134A in the first direction D1 through a central void 68 of the divider wall 66. As best shown in FIG. 1, the second rotor shaft portion 134B is coupled to the reduction gearset 94 to transmit torque between the electric machine 90 and the differential assembly 98. Other configurations of coupling the rotor 122 of the electric machine 90 to the reduction gearset 94 are contemplated. With continued reference to FIG. 1, in the illustrated configuration, the rotor 122 defines a central bore 130 extending along the first axis A1, and the electric drive unit 50 further includes a link shaft 138 coupled to a first side gear 186 of the differential assembly 98 (described in further detail below) and extending from the first side gear 186 through the central bore 130 of the rotor 122. In these configurations, as illustrated schematically in FIG. 1, the end of the link shaft 138 opposite the first side gear 186 is configured to be coupled to a first output shaft 270 of the electric drive unit 50.

As also described above, the electric drive unit 50 includes the reduction gearset 94 for transmitting torque between the electric machine 90 and the differential assembly 98. The configuration of the reduction gearset 94 is not limited for the purposes of this disclosure. Exemplary configurations of the reduction gearset 94 include planetary gearsets, layshaft gearsets, countershaft gearsets, parallel axis gearsets, compound gearsets, and multi-stage reduction gearsets. Where the reduction gearset 94 includes planetary gearsets, the reduction gearset 94 may include a single-stage planetary gearset or multi-stage planetary gearsets. As best shown in FIG. 1, in the illustrated configuration, the reduction gearset 94 includes a first planetary gearset 142 and a second planetary gearset 162 arranged in series to constitute a two-stage planetary reduction gearset. In the illustrated embodiment, the reduction gearset 94 is disposed in the second chamber 74. However, it is to be appreciated that the reduction gearset 94 can alternatively be disposed in the first chamber 70.

The first planetary gearset 142 includes a first sun gear 146 coupled to the electric machine 90 to transmit torque between the electric machine 90 and the reduction gearset 94. More specifically, the first sun gear 146 may be coupled to the second rotor shaft portion 134B for rotation with the rotor 122 about the first axis A1. In the illustrated configuration, the first sun gear 146 is integral with the second rotor shaft portion 134B, but configurations where the first sun gear 146 is a separate component coupled to the rotor shaft 134 are contemplated. The first planetary gearset 142 also includes a first ring gear 150 fixed to the housing assembly 54 such that the first ring gear 150 is rotationally constrained relative to the housing assembly 54. For example, the first ring gear 150 may be welded or otherwise fastened to the housing assembly 54. The first planetary gearset 142 further includes a plurality of first planet gears 154 disposed between and meshed with the first sun gear 146 and the first ring gear 150 such that the plurality of first planet gears 154 orbit about the first axis A1 in response to rotation of the first sun gear 146. The first planetary gearset 142 additionally includes a first planet carrier 158 coupled to the plurality of first planet gears 154. More specifically, the first planet carrier 158 maintains an angular spacing about the first axis A1 between each planet gear 154 of the plurality of first planet gears 154. Accordingly, the first planet carrier 158 rotates about the first axis A1 as the plurality of first planet gears 154 orbit about the first axis A1. In other words, during operation of the first planetary gearset 142, rotation of the first sun gear 146 at a first input speed causes the first planet gears 154 to orbit about the first axis A1, thereby driving rotation of the first planet carrier 158 about the first axis A1 at a first output speed less than the first input speed. The ratio of the first input speed to the first output speed defines the gear ratio of the first planetary gearset 142 of the illustrated reduction gearset 94.

The second planetary gearset 162 includes a second sun gear 166 coupled to the first planet carrier 158 for rotation with the first planet carrier 158 about the first axis A1. Stated differently, the output of the first planetary gearset 142 (i.e., the first planet carrier 158) is coupled to the input of the second planetary gearset 162 (i.e., the second sun gear 166) such that the first planetary gearset 142 and the second planetary gearset 162 are arranged in series. The second planetary gearset 162 also includes a second ring gear 170 fixed to the housing assembly 54 such that the second ring gear 170 is rotationally constrained relative to the housing assembly 54. For example, the second ring gear 170 may be welded or otherwise fastened to the housing assembly 54. The second planetary gearset 162 further includes a plurality of second planet gears 174 disposed between and meshed with the second sun gear 166 and the second ring gear 170 such that the plurality of second planet gears 174 orbit about the first axis A1 in response to rotation of the second sun gear 166. The second planetary gearset 162 additionally includes a second planet carrier 178 coupled to the plurality of second planet gears 174 and the differential assembly 98 to transmit torque between the reduction gearset 94 and the differential assembly 98. More specifically, the second planet carrier 178 maintains an angular spacing about the first axis A1 between each planet gear 174 of the plurality of second planet gears 174. Accordingly, the second planet carrier 178 rotates about the first axis A1 as the plurality of second planet gears 174 orbit about the first axis A1. In other words, during operation of the second planetary gearset 162, rotation of the second sun gear 166 at a second input speed causes the second planet gears 174 to orbit about the first axis A1, thereby driving rotation of the second planet carrier 178 about the first axis A1 at a second output speed less than the second input speed. The ratio of the second input speed to the second output speed defines the gear ratio of the second planetary gearset 162 of the illustrated reduction gearset 94. Cumulatively, the product of the gear ratio of the first planetary gearset 142 and the gear ratio of the second planetary gearset 162 defines the overall gear ratio of the reduction gearset 94. The reduction gearset 94 may have a gear ratio of 2:1 or greater, 5:1 or greater, 10:1 or greater, 15:1 or greater, 20:1 or greater, etc.

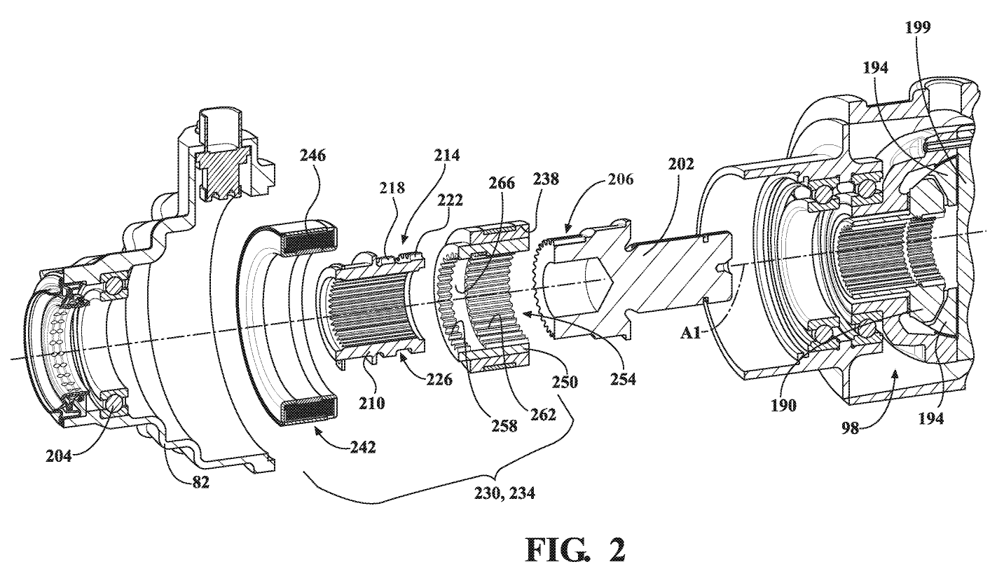

As also described above, the electric drive unit 50 includes the differential assembly 98. The differential assembly 98 is generally configured to receive torque generated by the electric machine 90 (and provided to the differential assembly 98 via the reduction gearset 94) and to transmit that torque to first and second output shafts 270, 274 while accommodating differential rotation of the first output shaft 270 and the second output shaft 274 relative to one another. As best shown in FIGS. 1 and 2, the differential assembly 98 includes a pinion carrier 182 supported for rotation about the first axis A1. In the illustrated configuration, the second planet carrier 178 of the second planetary gearset 162 is coupled to the pinion carrier 182 for rotation with the pinion carrier 182 about the first axis A1 to transmit torque between the reduction gearset 94 and the differential assembly 98. However, other configurations of transferring torque between the pinion carrier 182 and the reduction gearset 94 are contemplated.

With continued reference to FIGS. 1 and 2, the differential assembly 98 also includes a first side gear 186 disposed in the pinion carrier 182 for rotation relative to the pinion carrier 182 about the first axis A1. The first side gear 186 is configured to be coupled (directly or indirectly through an intermediate component, such as the link shaft 138 described above) to the first output shaft 270. Other configurations for coupling the first side gear 186 to the first output shaft 270 are contemplated. The differential assembly 98 further includes a second side gear 190 disposed in the pinion carrier 182 opposite the first side gear 186 for rotation relative to the pinion carrier 182 about the first axis A1. The differential assembly 98 further includes a plurality of pinion gears 194 coupled to the pinion carrier 182 for rotation about a second axis A2 transverse to the first axis A1. For example, the plurality of pinion gears 194 may be coupled to the pinion carrier 182 via a pinion shaft 198 coupled to the pinion carrier 182 for rotation with the pinion carrier 182 about the first axis A1, with the pinion shaft 198 extending along the second axis A2 and the plurality of pinion gears 194 coupled to the pinion shaft 198 for rotation about the second axis A2. Each pinion gear 194 is meshed with the first side gear 186 and the second side gear 190 to transfer torque from the pinion carrier 182 to the first side gear 186 and the second side gear 190. The plurality of pinion gears 194 permits the first side gear 186 and the second side gear 190 to rotate at different angular speeds relative to one another. Thus, for example, when the vehicle including the electric drive unit 50 turns or one drive wheel experiences a traction difference, the plurality of pinion gears 194 rotate about the second axis A2 to accommodate the relative speed differential between the first side gear 186 and the second side gear 190 while maintaining torque transfer to at least one of the first side gear 186 and the second side gear 190.

With continued reference to FIG. 2, the electric drive unit 50 further includes a stub shaft 202 disposed in the housing interior 62 and coupled to the second side gear 190 for rotation with the second side gear 190 about the first axis A1. The stub shaft 202 includes a first spline portion 206 disposed annularly about the first axis A1. In the illustrated configuration, the stub shaft 202 is directly coupled to the second side gear 190 for rotation with the second side gear 190 about the first axis A1; however, configurations where the stub shaft 202 is coupled to the second side gear 190 indirectly through an intermediate component for rotation with the second side gear 190 about the first axis A1 are also contemplated.

With continued reference to FIG. 2, the electric drive unit 50 further includes an axle receiving member 210 disposed adjacent to the stub shaft 202 in the housing interior 62 for rotation relative to the stub shaft 202 about the first axis A1. In the illustrated configuration, the electric drive unit 50 further includes a bearing 204 disposed between the second end cover 82 and the axle receiving member 210 for supporting the axle receiving member 210 for rotation relative to the second end cover 82 about the first axis A1. Other configurations for supporting the axle receiving member 210 for rotation relative to the housing assembly 54 are contemplated. The axle receiving member 210 includes a second spline portion 214 disposed adjacent to the first spline portion 206 of the stub shaft 202, and the axle receiving member 210 is configured to be coupled to the second output shaft 274.

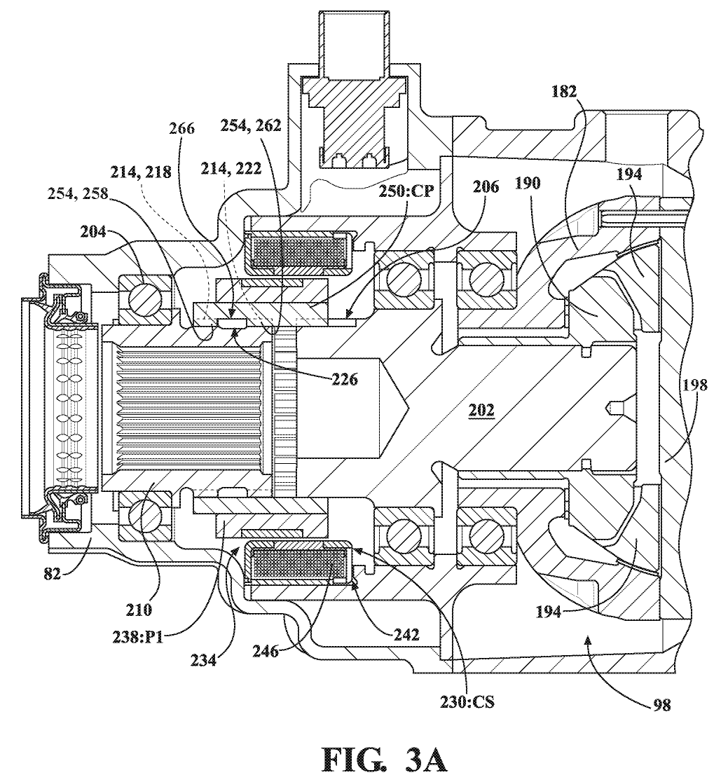

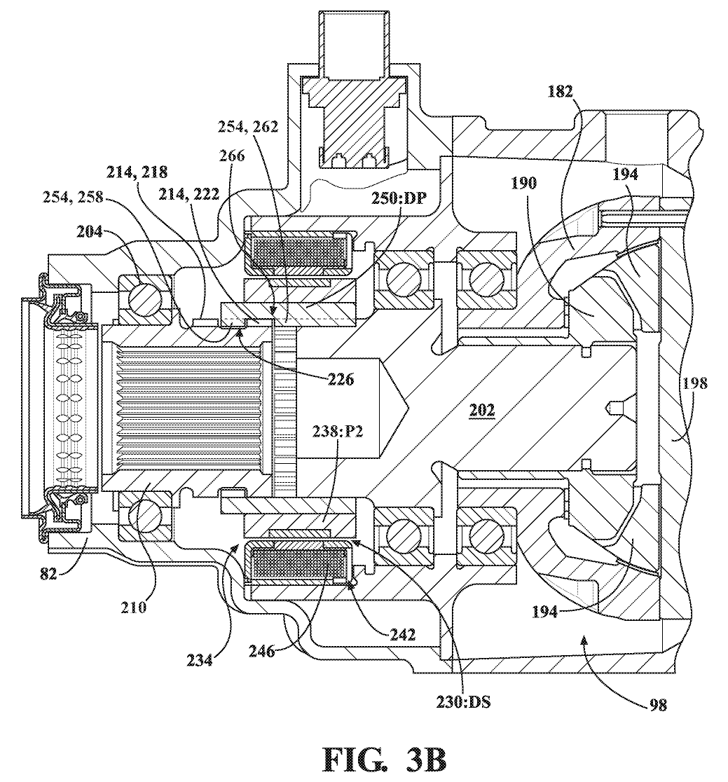

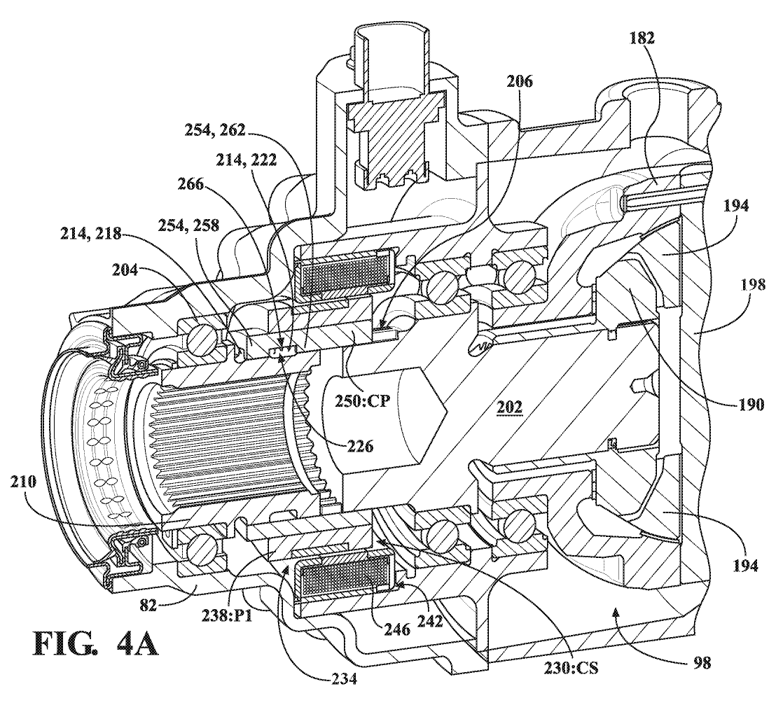

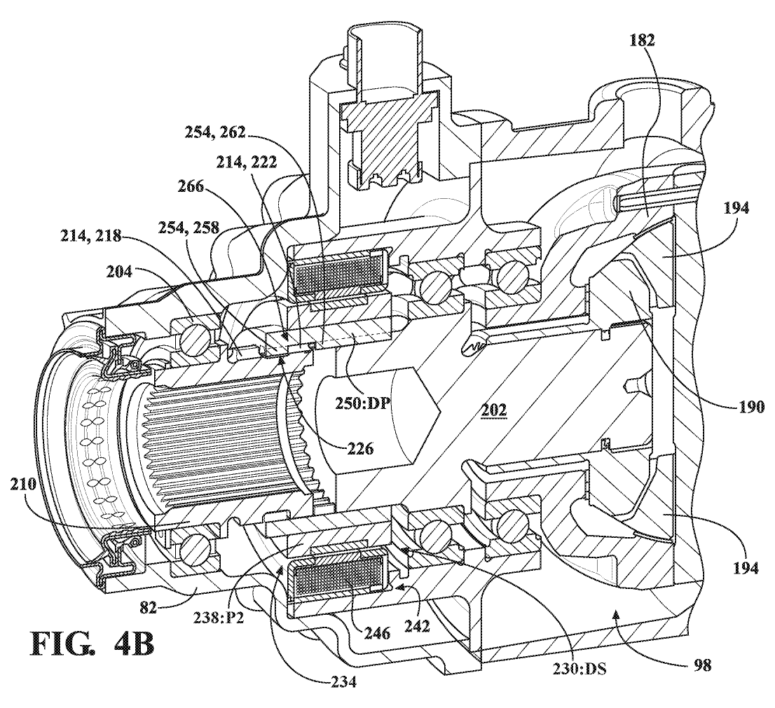

As best shown in FIGS. 2-4B, the electric drive unit 50 further includes a disconnect assembly 230 operable between (i) a connected state CS where the disconnect assembly 230 couples the axle receiving member 210 and the stub shaft 202 such that the differential assembly 98 transfers torque to the axle receiving member 210 and the first side gear 186, and (ii) a disconnected state DS where the disconnect assembly 230 decouples the axle receiving member 210 and the stub shaft 202 such that the differential assembly 98 does not transfer torque to the axle receiving member 210. In other words, as best shown in FIGS. 3A and 4A, in the connected state CS, the axle receiving member 210 and the stub shaft 202 rotate together about the first axis A1 such that the input torque received by the pinion carrier 182 from the reduction gearset 94 is transferred through the plurality of pinion gears 194 to both the first side gear 186 and the second side gear 190, and in turn to the first output shaft 270 (via the link shaft 138) and to the second output shaft 274 (via the stub shaft 202 and the axle receiving member 210). As best shown in FIGS. 3B and 4B, in the disconnected state DS, the axle receiving member 210 is permitted to rotate relative to the stub shaft 202 about the first axis A1 such that the disconnect assembly 230 inhibits torque transfer between the stub shaft 202 and the axle receiving member 210. Stated differently, in the disconnected state DS, the disconnect assembly 230 isolates the electric machine 90, the reduction gearset 94, and the pinion carrier 182 from the axle receiving member 210 and the second output shaft 274, thereby inhibiting back-driving of the electric machine 90 from the wheels of the vehicle when the electric machine 90 is not being used to propel the vehicle and reducing parasitic losses attributable to continued rotation of these components.

As best shown in FIGS. 2-4B, the disconnect assembly 230 generally includes an actuator 234 and a shift collar 250. The actuator 234 includes an armature 238 selectively movable along the first axis A1 between a first position P1 and a second position P2 spaced from the first position P1 along the first axis A1. In the illustrated configuration, the actuator 234 is an electromagnetic actuator 234. In these configurations, the actuator 234 further includes a stator 242 including an electromagnetic coil 246 configured to be energized to electromagnetically interact with the armature 238 to move the armature 238 along the first axis A1 between the first position P1 and the second position P2. The stator 242 of the actuator 234 is typically stationary relative to the housing assembly 54. For example, the stator 242 of the actuator 234 may be coupled to or supported by the housing assembly 54 such that the stator 242 is rotationally and translationally constrained relative to the housing assembly 54 while the armature 238 is selectively movable along the first axis A1 relative to the housing assembly 54 and the stator 242 in response to energization of the electromagnetic coil 246. Other configurations for coupling the stator 242 to the housing assembly 54 are contemplated, and other configurations of the actuator 234 (such as hydraulic actuators) are also contemplated.

In the illustrated configuration, the actuator 234 is a bistable actuator 234 such that the actuator 234 is configured to retain the armature 238 in either of the first position P1 and the second position P2 in an absence of energization of the electromagnetic coil 246. Stated differently, in bistable configurations, the armature 238 has two stable positions corresponding to the first position P1 and the second position P2, and the electromagnetic coil 246 is energized to drive the armature 238 between these two stable positions rather than to retain the armature 238 in either position. Bistable operation advantageously reduces the electrical energy consumed by the actuator 234 during operation of the disconnect assembly 230 in either the connected state CS or the disconnected state DS. In other configurations, the actuator 234 may be a monostable actuator 234 such that the actuator 234 is configured to retain the armature 238 in one of the first position P1 and the second position P2 in an absence of energization of the electromagnetic coil 246. In such monostable configurations, one of the first position P1 and the second position P2 of the armature 238 may be a default stable position and the electromagnetic coil 246 may be continuously energized to retain the armature 238 in the other of the first position P1 and the second position P2 against a biasing force that otherwise returns the armature 238 to the default stable position in the absence of energization.

As best shown in FIGS. 2-4B, the disconnect assembly 230 further includes a shift collar 250 including a shift spline portion 254 disposed annularly about the first axis A1 and engaged with one of the first spline portion 206 of the stub shaft 202 and the second spline portion 214 of the axle receiving member 210 for rotation with the one of the first spline portion 206 and the second spline portion 214 about the first axis A1. Stated differently, the shift spline portion 254 is either (i) always engaged with the first spline portion 206 of the stub shaft 202 for rotation with the first spline portion 206 about the first axis A1 and is configured to selectively further engage the second spline portion 214 of the axle receiving member 210 to arrange the disconnect assembly 230 in the connected state CS, or (ii) always engaged with the second spline portion 214 of the axle receiving member 210 for rotation with the second spline portion 214 about the first axis A1 and is configured to selectively further engage the first spline portion 206 of the stub shaft 202 to arrange the disconnect assembly 230 in the connected state CS. In the configuration illustrated throughout the FIGS., the shift spline portion 254 is illustrated as always engaged with the first spline portion 206 of the stub shaft 202 for rotation with the first spline portion 206 about the first axis A1 and is configured to selectively further engage the second spline portion 214 of the axle receiving member 210 to arrange the disconnect assembly 230 in the connected state CS, but the opposite configuration is also contemplated. With continued reference to FIGS. 2-4B, the shift collar 250 is coupled to the armature 238 for translation along the first axis A1 such that the shift collar 250 translates along the first axis A1 between a connected position CP and a disconnected position DP in response to movement of the armature 238 between the first position P1 and the second position P2. In the illustrated configuration, the shift collar 250 is directly coupled to the armature 238 for translation along the first axis A1; however, configurations where the shift collar 250 is coupled to the armature 238 indirectly through one or more intermediate components for translation along the first axis A1 are also contemplated.

As best shown in FIGS. 3A and 4A, in response to movement of the armature 238 to the first position P1, the shift collar 250 is configured to translate along the first axis A1 to the connected position CP where the shift spline portion 254 further engages the other of the first spline portion 206 and the second spline portion 214 such that the stub shaft 202 and the axle receiving member 210 are connected for concurrent rotation about the first axis A1 to arrange the disconnect assembly 230 in the connected state CS. As best shown in FIGS. 3B and 4B, in response to movement of the armature 238 to the second position P2, the shift collar 250 is configured to translate along the first axis A1 to the disconnected position DP where the shift spline portion 254 disengages the other of the first spline portion 206 and the second spline portion 214 such that the stub shaft 202 and the axle receiving member 210 are permitted to rotate relative to each other about the first axis A1 to arrange the disconnect assembly 230 in the disconnected state DS. In the configuration illustrated throughout the FIGS., in response to movement of the armature 238 to the first position P1, the shift collar 250 is configured to translate along the first axis A1 to the connected position CP where the shift spline portion 254 further engages the second spline portion 214 of the axle receiving member 210 such that the stub shaft 202 and the axle receiving member 210 are connected for concurrent rotation about the first axis A1 to arrange the disconnect assembly 230 in the connected state CS, and in response to movement of the armature 238 to the second position P2, the shift collar 250 is configured to translate along the first axis A1 to the disconnected position DP where the shift spline portion 254 disengages the second spline portion 214 of the axle receiving member 210 such that the stub shaft 202 and the axle receiving member 210 are permitted to rotate relative to each other about the first axis A1 to arrange the disconnect assembly 230 in the disconnected state DS. The opposite configuration, in which the shift spline portion 254 is always engaged with the second spline portion 214 of the axle receiving member 210 and selectively further engages the first spline portion 206 of the stub shaft 202, is also contemplated.

As best shown in FIGS. 3A, 3B, 4A, and 4B, in the illustrated configuration, the second spline portion 214 of the axle receiving member 210 includes a first spline landing 218 and a second spline landing 222 spaced from the first spline landing 218 along the first axis A1 to define a first gap 226 between the first spline landing 218 and the second spline landing 222, with the first gap 226 being free of splines. The shift spline portion 254 of the shift collar 250 defines a third spline landing 258 and a fourth spline landing 262 spaced from the third spline landing 258 along the first axis A1 to define a second gap 266 between the third spline landing 258 and the fourth spline landing 262, with the second gap 266 being free of splines. As best shown in FIGS. 3A and 4A, in response to movement of the shift collar 250 to the connected position CP, the third spline landing 258 of the shift collar 250 is engaged with the first spline landing 218 of the axle receiving member 210, and the fourth spline landing 262 of the shift collar 250 is engaged with the second spline landing 222 of the axle receiving member 210 to rotationally couple the shift collar 250 to the axle receiving member 210 about the first axis A1. As best shown in FIGS. 3B and 4B, in response to movement of the shift collar 250 to the disconnected position DP, the third spline landing 258 of the shift collar 250 is disposed in the first gap 226 of the axle receiving member 210, and the second spline landing 222 of the axle receiving member 210 is disposed in the second gap 266 of the shift collar 250. Accordingly, in the disconnected state DS, the third spline landing 258 and the second spline landing 222 each occupy a respective gap that is free of splines such that no rotational coupling is established between the axle receiving member 210 and the shift collar 250, and the axle receiving member 210 is thereby permitted to rotate relative to the shift collar 250 and the stub shaft 202 about the first axis A1. The arrangement of the first spline landing 218 and the second spline landing 222 of the axle receiving member 210 relative to the third spline landing 258 and the fourth spline landing 262 of the shift collar 250 facilitates selective disconnection of the shift spline portion 254 and the second spline portion 214 over a relatively short axial travel of the shift collar 250 along the first axis A1, thereby reducing the axial envelope required to accommodate the disconnect assembly 230 within the housing interior 62.

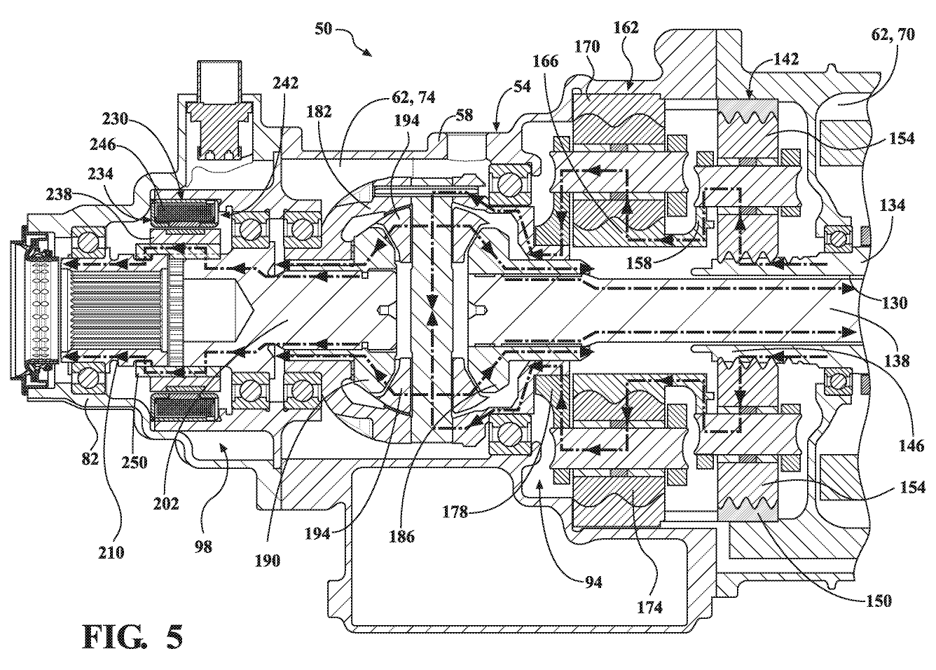

FIG. 5 illustrates the torque flow through the illustrated configuration of electric drive unit 50 when the disconnect assembly 230 is in the connected state CS. The illustrated torque flow extends from the electric machine 90 through the reduction gearset 94 to the differential assembly 98, where the torque is distributed between the first side gear 186 and the second side gear 190. More specifically, rotation generated by the rotor 122 is carried by the rotor shaft 134 to the first sun gear 146, transferred through the first planetary gearset 142 to the first planet carrier 158, passed from the first planet carrier 158 to the second sun gear 166, and then transferred through the second planetary gearset 162 to the second planet carrier 178 and to the pinion carrier 182 of the differential assembly 98. The pinion carrier 182 transfers the torque through the plurality of pinion gears 194 to the first side gear 186 and the second side gear 190. The first side gear 186 transfers the torque to the first output shaft 270 through the link shaft 138, and the second side gear 190 transfers the torque to the stub shaft 202, through the shift collar 250 engaged with both the first spline portion 206 of the stub shaft 202 and the second spline portion 214 of the axle receiving member 210, to the axle receiving member 210, and on to the second output shaft 274. When the disconnect assembly 230 is in the disconnected state DS, the torque path between the stub shaft 202 and the axle receiving member 210 is interrupted such that rotation of the second output shaft 274 is no longer transmitted through the axle receiving member 210 to the stub shaft 202, and the electric machine 90, the reduction gearset 94, and the pinion carrier 182 are isolated from the second output shaft 274.

Several embodiments have been described in the foregoing description. However, the embodiments described herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular. It will be further appreciated that the terms “include,” “includes,” and “including” have the same meaning as the terms “comprise,” “comprises,” and “comprising.”

What is claimed is:

1. An electric drive unit comprising:
a housing assembly extending along a first axis and defining a housing interior;
an electric machine disposed in said housing interior;
a reduction gearset disposed in said housing interior and coupled to said electric machine;
a differential assembly disposed in said housing interior and coupled to said reduction gearset such that said reduction gearset transmits torque between said electric machine and said differential assembly, said differential assembly comprising:
a pinion carrier supported for rotation about said first axis;
a first side gear disposed in said pinion carrier for rotation relative to said pinion carrier about said first axis, said first side gear configured to be coupled to a first output shaft;
a second side gear disposed in said pinion carrier opposite said first side gear for rotation relative to said pinion carrier about said first axis; and
a plurality of pinion gears coupled to said pinion carrier for rotation about a second axis transverse to said first axis, each of said plurality of pinion gears meshed with said first side gear and said second side gear to transfer torque from said pinion carrier to said first side gear and said second side gear;
a stub shaft disposed in said housing interior and coupled to said second side gear for rotation with said second side gear about said first axis and including a first spline portion;
an axle receiving member disposed adjacent to said stub shaft in said housing interior for rotation relative to said stub shaft about said first axis, said axle receiving member including a second spline portion disposed adjacent to said first spline portion of said stub shaft, and said axle receiving member configured to be coupled to a second output shaft; and
a disconnect assembly operable between (i) a connected state where said disconnect assembly couples said axle receiving member and said stub shaft such that said differential assembly transfers torque to said axle receiving member and said first side gear, and (ii) a disconnected state where said disconnect assembly decouples said axle receiving member and said stub shaft such that said differential assembly does not transfer torque to said axle receiving member, said disconnect assembly comprising:
an actuator including an armature selectively movable along said first axis between a first position and a second position spaced from said first position along said first axis; and
a shift collar including a shift spline portion disposed annularly about said first axis and engaged with one of said first spline portion of said stub shaft and said second spline portion of said axle receiving member for rotation with said one of said first spline portion and said second spline portion about the first axis, said shift collar coupled to said armature for translation along said first axis such that (i) in response to movement of said armature to said first position, said shift collar is configured to translate along said first axis to a connected position where said shift spline portion further engages the other of said first spline portion and said second spline portion such that said stub shaft and said axle receiving member are connected for concurrent rotation about said first axis to arrange said disconnect assembly in said connected state, and (ii) in response to movement of said armature to said second position, said shift collar is configured to translate along said first axis to a disconnected position where said shift spline portion disengages the other of said first spline portion and said second spline portion such that said stub shaft and said axle receiving member are permitted to rotate relative to each other about said first axis to arrange said disconnect assembly in said disconnected state.

2. The electric drive unit according to claim 1, wherein said shift spline portion is engaged with said first spline portion of said stub shaft for rotation with said first spline portion about the first axis such that (i) said shift spline portion further engages said second spline portion of said axle receiving member in said connected position, and (ii) said shift spline portion disengages said second spline portion of said axle receiving member in said disconnected position.

3. The electric drive unit according to claim 2, wherein said second spline portion includes a first spline landing and a second spline landing spaced from said first spline landing along said first axis to define a first gap between said first spline landing and said second spline landing, said first gap free of splines; and
wherein said shift spline portion defines a third spline landing, said third spline landing disposed in said first gap in response to movement of said shift collar to said disconnected position, and said third spline landing engaged with said first spline landing of said second spline portion of said axle receiving member in response to movement of said shift collar to said connected position.

4. The electric drive unit according to claim 3, wherein said shift spline portion further defines a fourth spline landing spaced from said third spline landing along said first axis to define a second gap between said third spline landing and said fourth spline landing, said second gap free of splines; and
wherein said second spline landing of said second spline portion of said axle receiving member is disposed in said second gap in response to movement of said shift collar to said disconnected position, and said fourth spline landing engaged with said second spline landing of said second spline portion of said axle receiving member in response to movement of said shift collar to said connected position.

5. The electric drive unit according to claim 1, wherein said actuator further includes a stator including an electromagnetic coil configured to be energized to electromagnetically interact with said armature to move said armature between said first position and said second position.

6. The electric drive unit according to claim 5, wherein said actuator is monostable such that said actuator is configured to retain said armature in one of said first position and said second position in an absence of energization of said electromagnetic coil.

7. The electric drive unit according to claim 5, wherein said actuator is bistable such that said actuator is configured to retain said armature in either of said first position and said second position in an absence of energization of said electromagnetic coil.

8. The electric drive unit according to claim 1, wherein said housing assembly comprises a main housing body extending along said first axis between a first end and a second end spaced from said first end in a first direction along said first axis.

9. The electric drive unit according to claim 8, wherein said housing assembly further comprises a first end cover coupled to said first end of said main housing body to delimit said housing interior in a second direction opposite said first direction.

10. The electric drive unit according to claim 8, wherein said housing assembly further comprises a second end cover coupled to said second end of said main housing body to delimit said housing interior in said first direction.

11. The electric drive unit according to claim 10 further comprising a bearing disposed between said second end cover and said axle receiving member to support said axle receiving member for rotation relative to said second end cover about said first axis.

12. The electric drive unit according to claim 8, wherein said main housing body includes a divider wall that subdivides said housing interior into a first chamber extending along said first axis and delimited by said divider wall in said first direction, and a second chamber extending along said first axis delimited by said divider wall in a second direction opposite said first direction.

13. The electric drive unit according to claim 12, wherein said electric machine is disposed in said first chamber, said differential assembly is disposed in said second chamber, and said reduction gearset is disposed in said second chamber.

14. The electric drive unit according to claim 1, wherein said electric machine comprises:
a stator coupled to said housing assembly and disposed annularly about said first axis, said stator defining a stator bore; and
a rotor disposed in said stator bore for rotation relative to said stator about said first axis in response to energization of said stator.

15. The electric drive unit according to claim 14, wherein said rotor comprises a rotor body disposed in said stator bore and a rotor shaft extending along said first axis between:
a first rotor shaft portion coupled to said rotor body such that said rotor shaft rotates with said rotor about said first axis in response to energization of said stator; and
a second rotor shaft portion extending from said first rotor shaft portion and coupled to said reduction gearset to transmit torque between said electric machine and said differential assembly.

16. The electric drive unit according to claim 15, wherein said rotor defines a central bore extending along said first axis; and
wherein said electric drive unit further comprises a link shaft coupled to said first side gear and extending from said first side gear through said central bore of said rotor.

17. The electric drive unit according to claim 1, wherein said electric machine is an asynchronous induction motor.

18. The electric drive unit according to claim 1, wherein said reduction gearset comprises:
a first planetary gearset comprising:
a first sun gear coupled to said electric machine to transmit torque between said reduction gearset and said electric machine;
a first ring gear fixed to said housing assembly;
a plurality of first planet gears disposed between and meshed with said first sun gear and said first ring gear such that said plurality of first planet gears orbit about said first axis in response to rotation of said first sun gear; and
a first planet carrier coupled to said plurality of first planet gears such that said first planet carrier rotates about said first axis in response to rotation of said first sun gear; and
a second planetary gearset comprising:
a second sun gear coupled to said first planet carrier for rotation with said first planet carrier about said first axis;
a second ring gear fixed to said housing assembly;
a plurality of second planet gears disposed between and meshed with said second sun gear and said second ring gear such that said plurality of second planet gears orbit about said first axis in response to rotation of said second sun gear; and
a second planet carrier coupled to said plurality of second planet gears and said differential assembly to transmit torque between said reduction gearset and said differential assembly.
